(19) United States
(12) Patent Application Publication
(10) Pub. No.: US 2007/0003030 A1
(43) Pub. Date: Jan. 4, 2007

(54) Display device and multimedia output system utilizing the same

(75) Inventors: Chang-Han Shen, Hsinchu (TW); Li-Ying Chang, Taipei (TW)

Correspondence Address: QUINTERO LAW OFFICE, 1617 BROADWAY, 3RD FLOOR, SANTA MONICA, CA, 90404, US

(73) Assignee: MITAC TECHNOLOGY CORP., HSIN-CHU HSIEN (TW)

(21) Appl. No.: 11/233,821

(22) Filed: Sep. 23, 2005

(30) Foreign Application Priority Data
Jun. 21, 2005 (TW) TW94120569

(51) Int. Cl. H04M 11/00

(52) U.S. Cl. 379/88.14

(57) ABSTRACT

A display device. The receiver receives multimedia data including a video signal and an audio signal group. The panel displays the video signal. The processor decodes the audio signal group to a multi-sound signal group when the audio signal group only has two sounds. The multi-sound signal group includes a first and a second voice-frequency signal groups. The processor outputs the first and the second voice-frequency signal groups to a first and a second speaker group by a wired method and a wireless method, respectively.

### BACKGROUND

The disclosure relates to a display device, and more particularly to a display device outputting sounds to speakers by a wireless method.

Conventional display devices utilize a built-in left speaker and a built-in right speaker to output audio according to an audio signal group. Since the audio signal group only has two sounds, the output sounds are very monotonous.

To solve the above problem, a conventional method utilizes a digital signal processor (DSP) to transform an audio signal group having two sounds received by a display device into a surround sound format and outputs the transmitted audio signal group through the left and right speakers disposed in the display device.

Although a user can utilize two speakers to hear surround sounds generated by the DSP, the surround sounds are virtual. Therefore, a sound effect simulated by two speakers is unequal to that output by multiple speakers.

### SUMMARY

Display devices and multimedia output systems utilizing the same are provided. An exemplary embodiment of a display device comprises a receiver, a panel, and a processor. The receiver receives multimedia data comprising a video signal and an audio signal group. The panel displays the video signal. The processor decodes the audio signal group to a multi-sound signal group when the audio signal group only has two sounds. The multi-sound signal group comprises first and second voice-frequency signal groups. The processor outputs the first and the second voice-frequency signal groups to a first and a second speaker group by a wired method and a wireless method, respectively.

Multimedia output systems with display device are also provided. An exemplary embodiment of a multimedia output system with display device comprises a display device and a speaker group. The display device receives and processes multimedia data comprising a video signal and an audio signal group. The display device comprises a receiver, a panel, and a processor. The receiver receives multimedia data. The panel displays the video signal. The processor decodes the audio signal group to a multi-sound signal group when the audio signal group only has two sounds. The multi-sound signal group comprises a first and a second voice-frequency signal groups. The processor outputs the first and the second voice-frequency signal groups to a first and a second speaker group by a wired method and a wireless method, respectively.

The speaker group comprises a first speaker module and a second speaker module. The first speaker module electrically connects the display device and outputs a first sound according to the first video-frequency signal group. The second speaker module receives the second voice-frequency signal group by a wireless method and outputs a second sound according to the second voice-frequency signal group.

### BRIEF DESCRIPTION OF THE DRAWINGS

The invention can be more fully understood by reading the subsequent detailed description and examples with reference made to the accompanying drawings, wherein:

FIG. 1 is a block diagram of an embodiment of a multimedia output system;

FIG. 2a is a schematic diagram of an embodiment of a speaker group;

FIG. 2b is a schematic diagram of another embodiment of the speaker group;

FIG. 3 is a schematic diagram of an embodiment of the multimedia output system;

FIG. 4 is a schematic diagram of an embodiment of the display device;

FIG. 5 is a block diagram of the processor.

### DETAILED DESCRIPTION

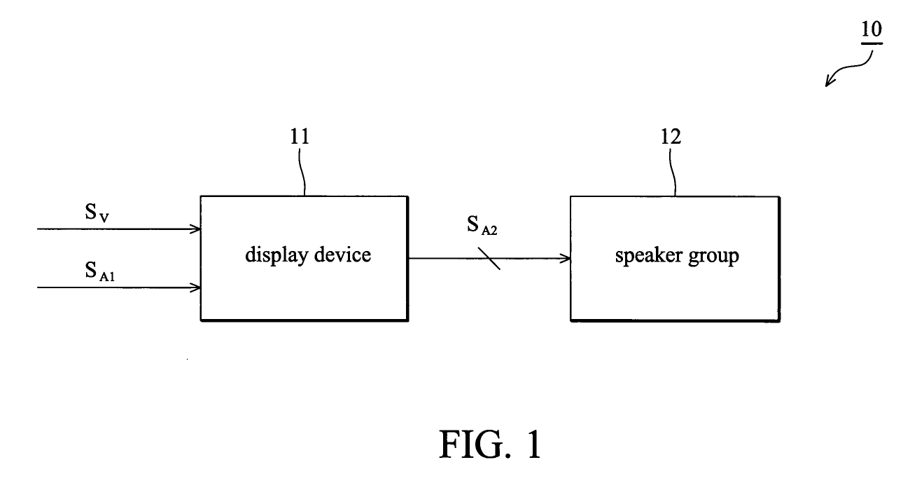

FIG. 1 is a block diagram of an embodiment of a multimedia output system. Multimedia output system 10 comprises a display device 11 and a speaker group 12. Display device 11 receives and processes multimedia data comprising a video signal Sᵥ and an audio signal group S_{A1}.

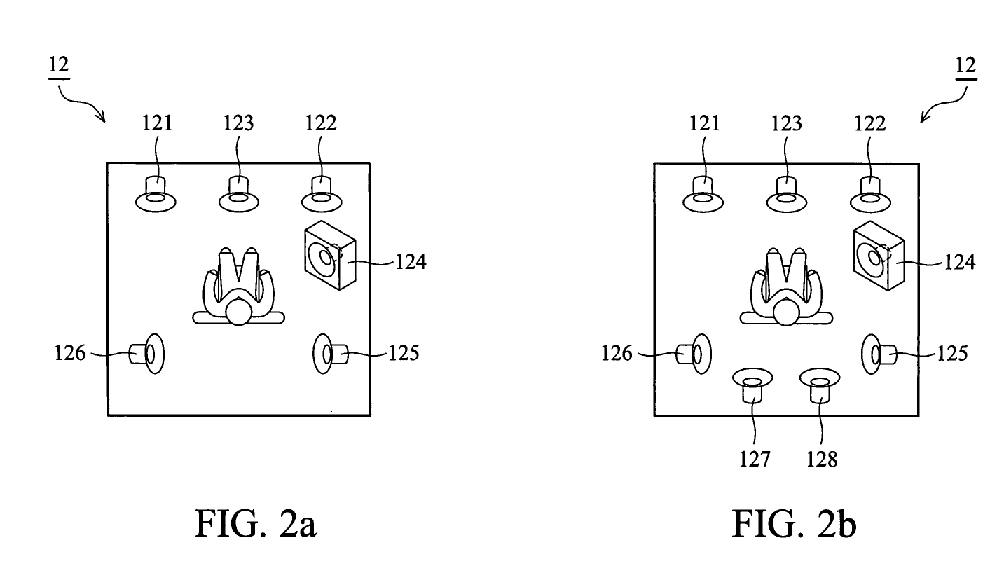

FIG. 2a is a schematic diagram of an embodiment of a speaker group. Speaker group 12 comprises a left front speaker 121, a right front speaker 122, a center speaker 123, a woofer speaker 124, a right rear speaker 125, and a left rear speaker 126.

Each speaker indicates a soundtrack for outputting a corresponding sound. Since one sound output from woofer speaker 124 is typically recorded with a lower resolution than the other sounds, six-soundtrack audio is sometimes referred to as 5.1 audio.

FIG. 2b is a schematic diagram of another embodiment of the speaker group 12. Speaker group 12 comprises a left front speaker 121, a right front speaker 122, a center speaker 123, a woofer speaker 124, a right rear speaker 125, a left rear speaker 126, and back surround speakers 127 and 128. Eight-soundtrack audio shown in FIG. 2b is called 7.1 audio. If one back surround soundtrack is omitted, the seven-soundtrack audio is called 6.1 audio.

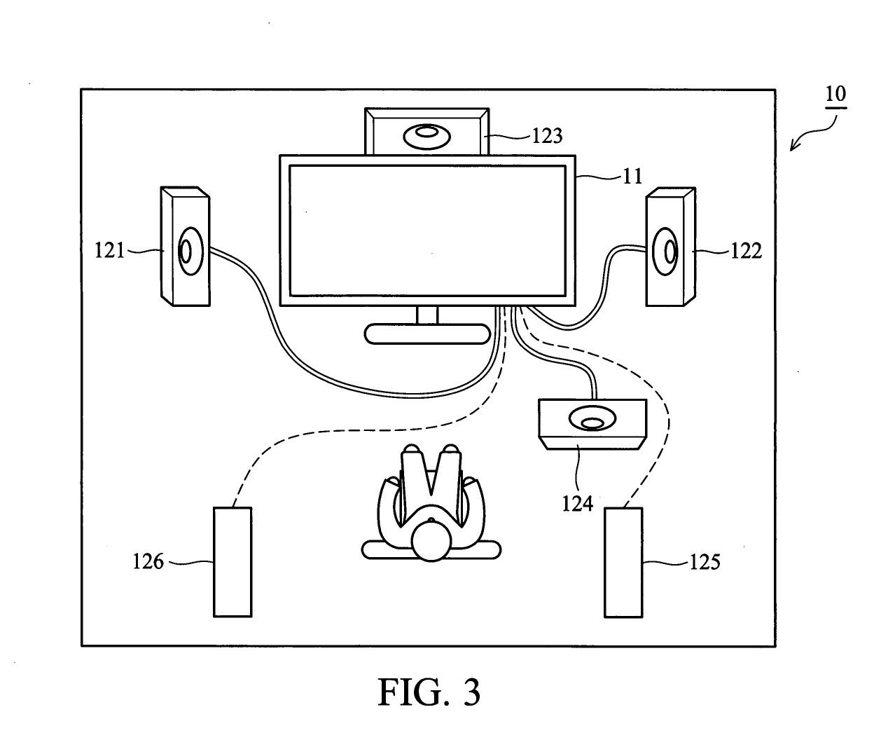

FIG. 3 is a schematic diagram of an embodiment of the multimedia output system. With reference to FIG. 2a, display device 11 is coupled to left front speaker 121, right front speaker 122, center speaker 123, woofer speaker 124, right rear speaker 125, and left rear speaker 126 by a connection line or a wireless method.

In this embodiment, since display device 11 is coupled to left front speaker 121, right front speaker 122, center speaker 123, and woofer speaker 124 by the connection line and coupled to right rear speaker 125, and left rear speaker 126 by the wireless method, a first speaker module is composed of left front speaker 121, right front speaker 122, center speaker 123, and woofer speaker 124 and a second speaker module is composed of right rear speaker 125 and left rear speaker 126. Display device 11 can couple to left front speaker 121, right front speaker 122, center speaker 123, or woofer speaker 124 by the wireless method.

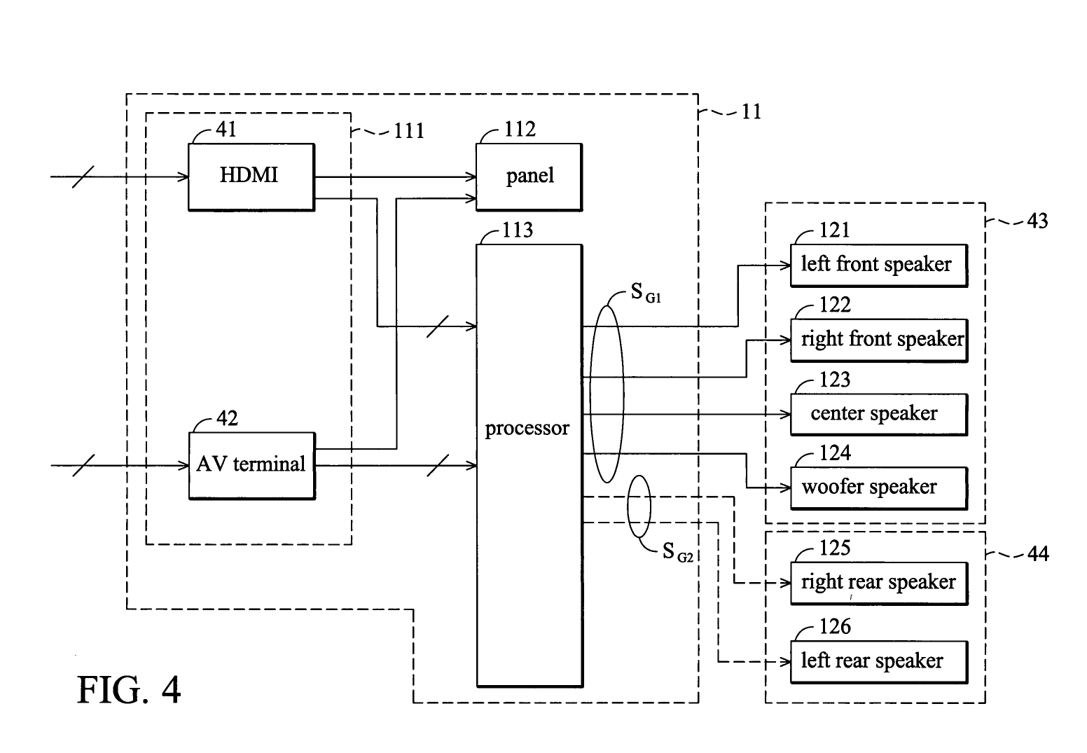

FIG. 4 is a schematic diagram of an embodiment of the display device. Display device 11 comprises a receiver 111, a panel 112, and a processor 113.

Receiver 111 comprises a high definition multimedia interface (HDMI) 41 and an audio/video (AV) terminal 42 for receiving multimedia data. HDMI 41 is a digital television interface and receives multimedia data comprising a video signal and an audio signal group having at least three sounds. AV terminal 42 is a generally television interface and receives multimedia data comprising a video signal and an audio signal group having two sounds.

Panel 112 displays the video signal received by HDMI 41 or AV terminal 42. Processor 113 processes the audio signal group received by HDMI 41 or AV terminal 42.

When processor 113 receives the audio signal group received by AV terminal 42, processor 113 decodes the audio signal group having two sounds to a multi-sound signal group having at least three sounds and divides the decoded the multi-sound group into a first and a second voice-frequency signal groups to speaker modules 43 and 44, respectively. When processor 113 receives the audio signal group received by HDMI 41, processor 113 directly divides the audio signal group having at least three sounds into a first and a second voice-frequency signal groups to speaker modules 43 and 44, respectively.

Processor 113 transforms the audio signal group having two sounds to the multi-soundtracks signal group having at least three sounds by a voice-frequency transmitting technology, for example, a Dolby Pro Logic II developed by Dolby laboratory. The voice-frequency transforming technology is well known to those skilled in the field.

Speaker group 12 is divided into speaker modules 43 and 44 according to the transmitting method of the audio signal group such that processor 113 must divide the multi-sound signal group into voice-frequency signal groups S_{G1} and S_{G2} Speaker module 43 receives voice-frequency signal groups S_{G1} via a connection line. Speaker module 44 receives voice-frequency signal groups S_{G2} by a wireless method.

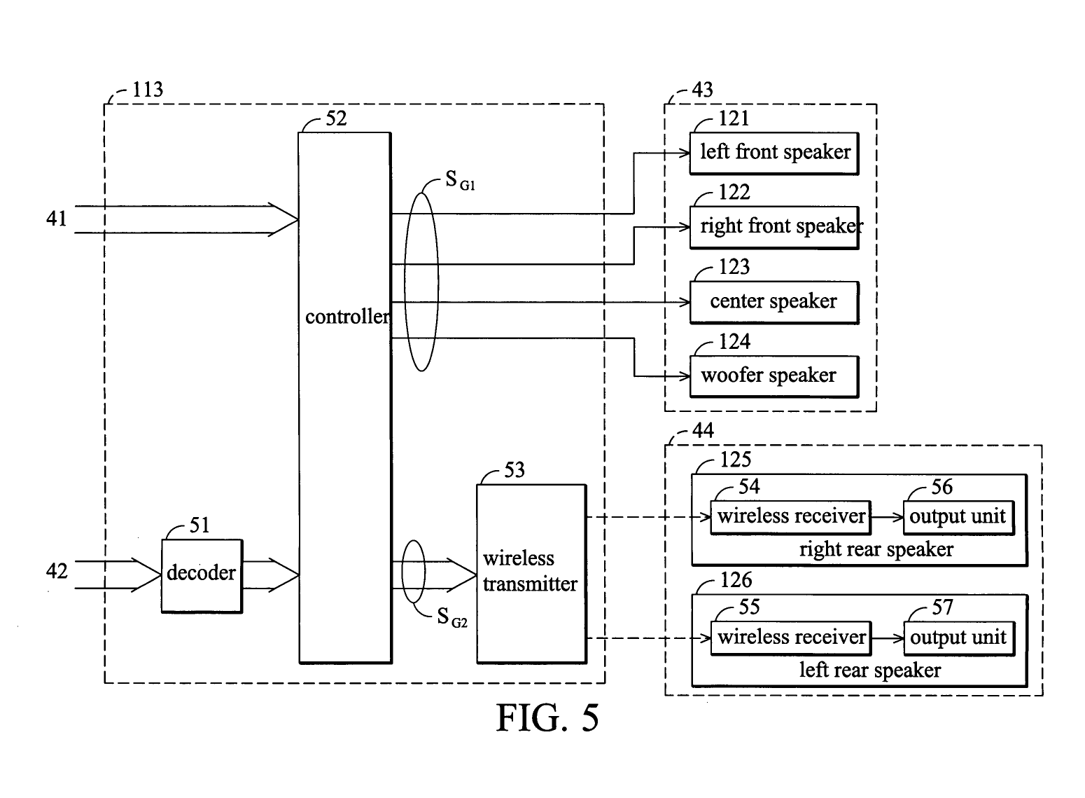

FIG. 5 is a block diagram of the processor. Decoder 51 decodes the audio signal group having two sounds received by AV terminal 42 to a multi-sound signal group having at least three sounds. Controller 52 divides the decoded sounds output from decoder 51 or divides the sounds output from HDMI 41 into voice-frequency signal groups S_{G1} and S_{G2}.

Speaker module 43 receives voice-frequency signal group S_{G1} and outputs corresponding sounds. Wireless transmitter 53 outputs the voice-frequency signal group S_{G2} to speaker module 44 by the wireless method such that speaker module 44 outputs corresponding sounds.

Output unit 56 outputs a sound according to voice-frequency signal group S_{G2} received by wireless receiver 54. Similarly, output unit 57 outputs a sound according to voice-frequency signal group S_{G2} received by wireless receiver 55.

Wireless transmitter 53 and wireless receivers 54 and 55 utilize a wireless method, such as a Bluetooth method or an infrared method to transmit the voice. Additionally, speaker module 44 may receive the same voice-frequency signal group such that rear right speaker 125 or rear left speaker 126 can be omitted from speaker module 44.

While the invention has been described by way of example and in terms of preferred embodiment, it is to be understood that the invention is not limited thereto. To the contrary, it is intended to cover various modifications and similar arrangements (as would be apparent to those skilled in the art) Therefore, the scope of the appended claims should be accorded the broadest interpretation so as to encompass all such modifications and similar arrangements.

What is claimed is:

1. A display device comprising:
a receiver receiving multimedia data comprising a video signal and an audio signal group;
a panel displaying the video signal; and
a processor decoding the audio signal group to a multi-sound signal group having at least three sounds when the audio signal group only has two sounds, wherein the multi-sound signal group comprises a first and a second voice-frequency signal groups and the processor outputs the first and the second voice-frequency signal groups to a first and a second speaker group by a wired method and a wireless method, respectively.

2. The display device as claimed in claim 1, wherein the processor divides the audio signal group into the first and the second voice-frequency signal groups and outputs the first and the second voice-frequency signal groups to the first and the second speaker group when the audio signal group has at least three sounds.

3. The display device as claimed in claim 2, wherein the receiver comprises a high definition multimedia interface (HDMI) for receiving the multimedia data.

4. The display device as claimed in claim 1, wherein the receiver comprises an audio/video (AV) terminal to receive the multimedia data.

5. The display device as claimed in claim 1, wherein the processor comprises a wireless transmitter for transmitting the second voice-frequency signal groups to the second speaker group.

6. The display device as claimed in claim 5, wherein the second speaker group comprises:
a wireless receiver receiving the second voice-frequency signal groups; and
an output unit outputting a sound according to the second voice-frequency signal groups.

7. The display device as claimed in claim 6, wherein the wireless transmitter and the wireless receiver transmit data by a Bluetooth method or an infrared method.

8. The display device as claimed in claim 1, wherein the second speaker group is a rear speaker.

9. The display device as claimed in claim 1, wherein the second speaker group comprises a left rear speaker and a right rear speaker.

10. The display device as claimed in claim 1, wherein the second speaker group is a woofer speaker.

11. The display device as claimed in claim 11, wherein the first speaker group comprises a left front speaker and a right front speaker.

12. A multimedia output system comprising:
a display device receiving multimedia data comprising a video signal and a audio signal group and comprising:
a receiver receiving the video signal and the audio signal group;
a panel displaying the video signal; and
a processor decoding the audio signal group to a multi-sound signal group when the audio signal group only has two sounds, wherein the multi-sound signal group comprises a first and a second voice-frequency signal groups and the processor outputs the first and the second voice-frequency signal groups to a first and a second speaker group by a wired method and a wireless method, respectively; and
a speaker group comprising:
a first speaker module electrically connecting the display device and outputting a first sound according to the first video-frequency signal group; and
a second speaker module receiving the second voice-frequency signal group by a wireless method and outputting a second sound a second speaker module according to the second voice-frequency signal group.

13. The multimedia output system as claimed in claim 12, wherein the processor divides the audio signal group into the first and the second voice-frequency signal groups and outputs the first and the second voice-frequency signal groups to the first and the second speaker group when the audio signal group has at least three sounds.

14. The multimedia output system as claimed in claim 13, wherein the receiver comprises a high definition multimedia interface (HDMI) for receiving the multimedia data.

15. The multimedia output system as claimed in claim 12, wherein the receiver comprises an audio/video (AV) terminal to receive the multimedia data.

16. The multimedia output system as claimed in claim 12, wherein the processor comprises a wireless transmitter for transmitting the second voice-frequency signal groups to the second speaker group.

17. The multimedia output system as claimed in claim 16, wherein the second speaker group comprises:
a wireless receiver receiving the second voice-frequency signal groups; and
a output unit outputting a sound according to the second voice-frequency signal groups.

18. The multimedia output system as claimed in claim 17, wherein the wireless transmitter and the wireless receiver transmit data by a Bluetooth method or an infrared method.

19. The multimedia output system as claimed in claim 12, wherein the second speaker group is a rear speaker.

20. The multimedia output system as claimed in claim 12, wherein the second speaker group comprises a left rear speaker and a right rear speaker.

21. The multimedia output system as claimed in claim 12, wherein the second speaker group is a woofer speaker.

22. The multimedia output system as claimed in claim 12, wherein the first speaker group comprises a left front speaker and a right front speaker.
